(19) United States
(12) Patent Application Publication
(10) Pub. No.: US 2010/0293025 A1
(43) Pub. Date: Nov. 18, 2010

(54) DIMENSIONAL SERVICE-ORIENTED ARCHITECTURE SOLUTION MODELING AND COMPOSITION

(75) Inventors: Giancarlo Carbone, Rome (IT); Teresa Abdel-Hamid, Columbus, OH (US); Ravi Subbaraman, Westerville, OH (US); Juan F. Vargas, Morrisville, NC (US)

Correspondence Address: DUKE W. YEE, YEE AND ASSOCIATES, P.C., P.O. BOX 802333, DALLAS, TX, 75380, US

(73) Assignee: International Business Machines Corporation, Armonk, NY (US)

(21) Appl. No.: 12/467,038

(22) Filed: May 15, 2009

(51) Int. Cl. G06Q 10/00

(52) U.S. Cl. 705/8; 705/7

(57) ABSTRACT

Transforming data provided in an enterprise management framework to provide solutions through a multidimensional model for a business process. Enterprise wide data may be aggregated and integrated through a three-dimensional visual model that synchronizes the data to enable relationships between multiple categories of data. The three-dimensional visual model enables the real-time composition of virtual solutions to business processes.

### BACKGROUND

1. Technical Field

This disclosure relates generally to the management and support of an enterprise portfolio and more specifically to the modeling and composition of a service-oriented architecture (SOA) solution.

2. Description of the Related Art

An enterprise may require information from a number of different tools or applications which may be used to manage portfolios within the business and planned various projects. In order to expand or create new capabilities for a specific line of business, or some fragment of a business within an enterprise, it may be necessary to assess the current state of the business by examining various pieces of information and data. Identifying existing assets of the business, their availability for use, and specific attributes of these assets may also be required in order to determine how to create a new capability, transaction, or some form of automation or other transaction.

The information or data required to make this assessment may exist in a number of disparate or individual tools, spreadsheets, directories, registries, reports, documents, and various other artifacts. It may be a challenge to access simultaneously or all at once, the data needed to identify existing assets and their availability for use in creating a solution to a problem that exists in a line of business or determining whether a new capability may be developed within existing line of business. Each tool that generates information for a particular line of business may need to be examined to determine and evaluate projects, plans, schedules, development processes, and other such information as may be required to develop or make an assessment.

### BRIEF SUMMARY

This disclosure describes a new approach to aggregating and integrating the data across lines of businesses, composing a solution to a business problem based on the aggregated data, and visualizing the data and the solution within a three-dimensional framework that has a user interface which is easily manipulated. The three-dimensional framework is particularly useful in a service-oriented architecture (SOA) domain to integrate different SOA components, but may also be used outside an SOA domain to integrate data or information together within a format that may be easily accessed or tracked within a user friendly interface.

According to one embodiment, in an enterprise management framework, a computer implemented method of modeling a solution for a business process with a tool that generates multiple dimensional views. The computer implemented method comprises automatically extracting a number of business components, from a component business model view, a number of components being associated with a project selected from a project view of the enterprise management framework, determining, from the component business model view, a number of services implemented for each extracted business component, identifying, from the component business model view, a specific component from the extracted business components based on a heat map value, aggregating the services associated with the identified component, identifying, through the project view, a number of projects linked to the aggregated services, determining, in a service composition view, tasks associated with a specific business process of a project that requires a solution, associating a task that requires a solution with an existing service, and composing, in the service composition view, the solution to a specific business process.

According to one embodiment, in an enterprise management framework, a computer implemented method of modeling a solution for a business process, the computer implemented method comprising steps of identifying existing artifacts required for a service-oriented architecture solution, establishing business rules for the identified artifacts, extracting information needed to model a proposed solution, and visually determining a solution for the business process.

According to one embodiment, a three dimensional interactive user interface tool, the three dimensional interactive user interface tool comprising a three dimensional user interface that adapts to changes in an environment, and a number of portions that perform navigation of a three dimensional model, wherein at least one portion of the tool is updated with informational data responsive to the navigation.

The embodiments of the disclosed processes and systems provide an advantage of bringing data together from various lines of business across an enterprise and allowing a user to have access to the data that is aggregated from various tools on a single screen.

Embodiments of the disclosed processes and systems may further provide the advantage of cross referencing assets in a service repository and business processes to identify a façade to do modeling and composition of service-orientated architecture (SOA) solutions.

The embodiments of the disclosed processes and system may also advantageously include the ability to navigate through the data in a three-dimensional user interface without having to access and extract data from individual tool sources.

These and other advantages will be more clearly understood from the detailed description taken in conjunction with the accompanying drawings and claims.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 illustrates an exemplary view of a screen that may be generated to visualize enterprise data according to one embodiment of the disclosure;

FIG. 2 illustrates a block diagram of an explanatory software environment that may be operable for various embodiments of the disclosure;

FIG. 3 illustrates a top level flow a diagram according to one embodiment of the disclosure;

FIG. 4 illustrates a detailed view of the service-orientated architecture dimensional engine component depicted in FIG. 2 in accordance with one embodiment of the disclosure;

FIG. 5 is a detailed view of the data source layer component depicted in FIG. 4 in accordance with one embodiment of the disclosure;

FIG. 6 is a detailed view of the data integration layer component depicted in FIG. 4 in accordance with one embodiment of the disclosure;

FIG. 7 illustrates a detailed view of the data presentation layer depicted in FIG. 4 in accordance with one embodiment of the disclosure;

FIGS. 8A and 8B illustrate a data model that represents a hierarchy of relationships according to one embodiment of the disclosure;

FIG. 9 illustrates different views of a three-dimensional modeling and composition of data according to one embodiment of the disclosure;

FIG. 10 illustrates a detailed view of the component business model according to one embodiment of the disclosure;

FIG. 11 illustrates a detailed view of the project view according to one embodiment of the disclosure;

FIG. 12 illustrates an operational view of the component business model view according to one embodiment of the disclosure;

FIG. 13 illustrates various relationships between elements in the component business model view according to one embodiment of the disclosure;

FIG. 14 illustrates details of a solution composition viewer according to one embodiment of the disclosure;

FIGS. 15A and 15B illustrate further operations of the solution composition viewer according to one embodiment of the disclosure;

FIGS. 16A and 16B illustrate further operations of the solution composition viewer according to one embodiment of the disclosure;

FIG. 17 illustrates a three-dimensional toolbar that may be used to control or display environment according to one embodiment of the disclosure;

FIG. 18 illustrates a top level flowchart in accordance with one embodiment of the disclosure; and

FIG. 19 illustrates a detailed flowchart of the flowchart depicted in FIG. 18 in accordance with one embodiment of the disclosure.

### DETAILED DESCRIPTION

Although an illustrative implementation of one or more embodiments are provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product tangibly embodied in any medium of expression with computer usable program code embodied in the medium.

Computer program code for carrying out operations of the present disclosure may be written in any combination of one or more programming languages, including an object oriented programming language such as Java™, Smalltalk, C++, or the like and conventional procedural programming languages, such as the “C” programming language or similar programming languages. Java™ is a trademark of Sun Microsystems, Inc., in the United States and other countries. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In embodiments of this disclosure, a tool extracts and aggregates information from disparate tools across an enterprise and integrates the information to allow easy accessibility of the information within a dimensional user framework that allows a user to have access to data on a single screen. The tool may process the data to allow modeling and composition of solutions in a service-oriented architecture (SOA). The model generated by the tool or engine may be generated in a three-dimensional cube format that may be controlled by a three-dimensional toolbar. The three-dimensional toolbar enables the three-dimensional cube to rotate and switch perspectives of the enterprise so that various solutions may be composed and modeled.

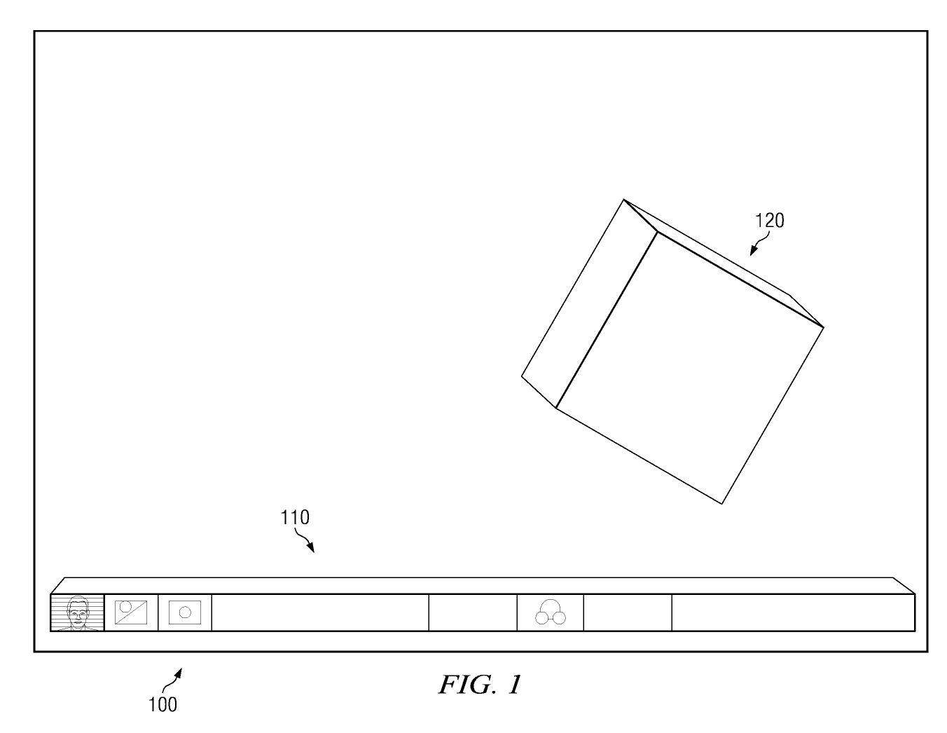

Turning now to FIG. 1, the visual representation 100 of a three-dimensional toolbar 110 in a three-dimensional cube 120 that represents an enterprise is illustrated. Three-dimensional toolbar 110 comprises a number of sections, detailed further in the disclosure that may be individually selected to control the orientation, interaction, display, and content of three-dimensional cube 120. Three-dimensional toolbar 110 may include options for viewing different perspectives of three-dimensional cube 120 within a framework. Three-dimensional cube 120 may comprise a number of perspectives of a business enterprise. For example, one perspective or view may enable the viewing of projects that may be related to various components of a business process. Another perspective or view may enable the viewing of business processes and may enable the selection of services to enable the business process. Three-dimensional toolbar 110 may flip or rotate three-dimensional cube 120 so that a particular perspective may be viewed. Each facet of the three-dimensional cube 120 may change content of the three-dimensional toolbar 110 to show appropriate menu selection, applicable to a current perspective on the three-dimensional view.

The contents of each perspective in three-dimensional cube 120 may vary depending on the particular enterprise and the lines of business included within a particular enterprise. Each facet of the three-dimensional cube 120 may represent a dimension of the enterprise or business within the enterprise and may enable the building of a solution for a particular problem identified within the enterprise.

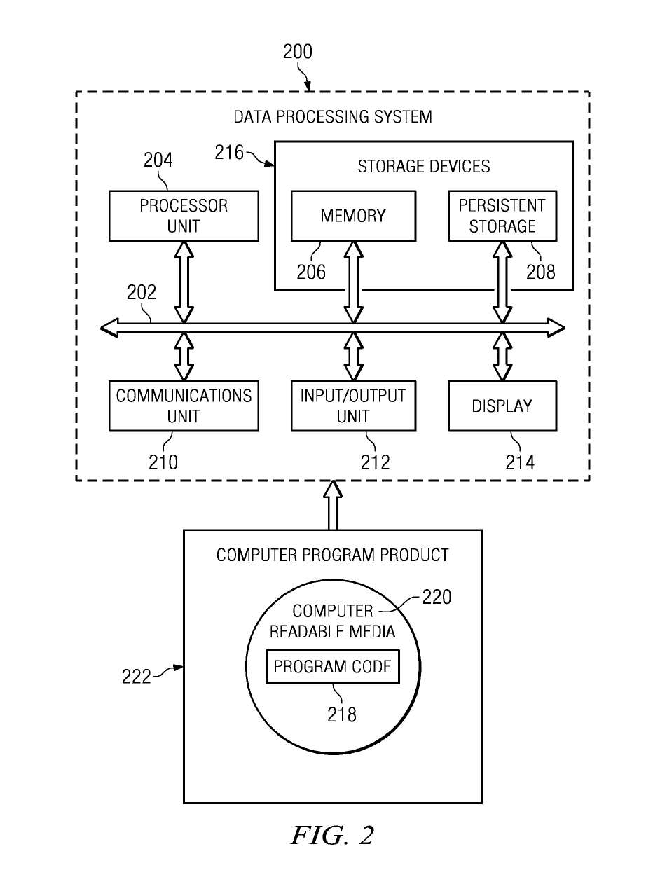

FIG. 2 illustrates a diagram of a data processing system as depicted in accordance with an illustrative embodiment. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications fabric 202. In these illustrative examples the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 220 also may take the form of a persistent storage, such as a hard drive, a thumb drive, or a flash memory that is connected to data processing system 200. The tangible form of computer readable media 220 is also referred to as computer recordable storage media. In some instances, computer readable media 220 may not be removable.

Alternatively, program code 218 may be transferred to data processing system 200 from computer readable media 220 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208 and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

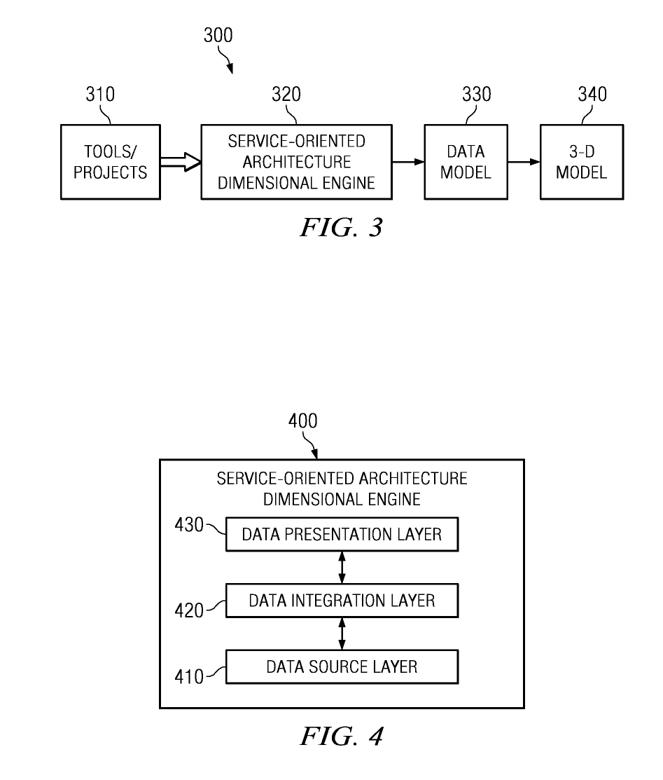

Turning now to FIG. 3, a top level flow diagram 300 illustrates operations according to an embodiment of the disclosure. An enterprise or line of business may include information for multiple sources. The information may include, without limitation, tool information, project information, application information, and other information that may be generated from various procedures known to one skilled in the art. Tool and project information 310 may be input to an engine that processes this information. In a preferred embodiment, this engine is a service-oriented architecture dimensional engine space 320. The SOA dimensional engine 320 receives tool, project, and other information in a specific format. The SOA architecture dimensional engine space 320 establishes a framework or data model 330 in which to aggregate the data and establish relationships within a data hierarchy. Data model 330 represents an information model in which tool data is deposited and attributes of tool data are identified. Three-dimensional modeler 340 may use information from data model 330 to display relationships defined in the hierarchy of data model 330 in a three-dimensional format. In a preferred embodiment, the three-dimensional format is displayed as a cube with a number of perspectives that may be displayed individually or simultaneously. The information of data model 330 may be required in a certain format. In an embodiment, the format may be in an Extensible-Markup Language (XML). However, other formats may be contemplated, such as, A Program Language (APL) and other languages that may be known to one skilled in the art.

Turning now to FIG. 4, the details of a service-oriented architecture dimensional engine 400 is illustrated. The service-oriented architecture dimensional engine 400 may be represented as comprised of a number of layers that perform various tasks. Data source layer 410 may comprise a repository of information that is extracted from a number of disparate tools, applications, and databases. Data integration layer 420 may hold information or data from data source layer 410 and may add, delete, modify or otherwise transform the loaded data to generate a three-dimensional visual object for visualization. Through data extracted from data source layer 410 may include specific information needed by data integration layer 420. Information may include, but is no way limited to, project name, project resources, project number, project budget, project states, and other such information that may identify a line of business within an enterprise.

Data presentation layer 430 represents a visualization layer that parses the data received from the data integration layer 420 and shows how all the data is connected through a three-dimensional model cube. For example, each facet of the cube may represent a dimension of the project. A dimension may include project attributes, activities, rules, timelines, staffing, and other such elements that may be known to one skilled in the art. Data presentation layer 430 may also define relationships within the data and enable conditions to be applied to the existing relationships to determine or build solutions to potential or existing problems within the data relationships.

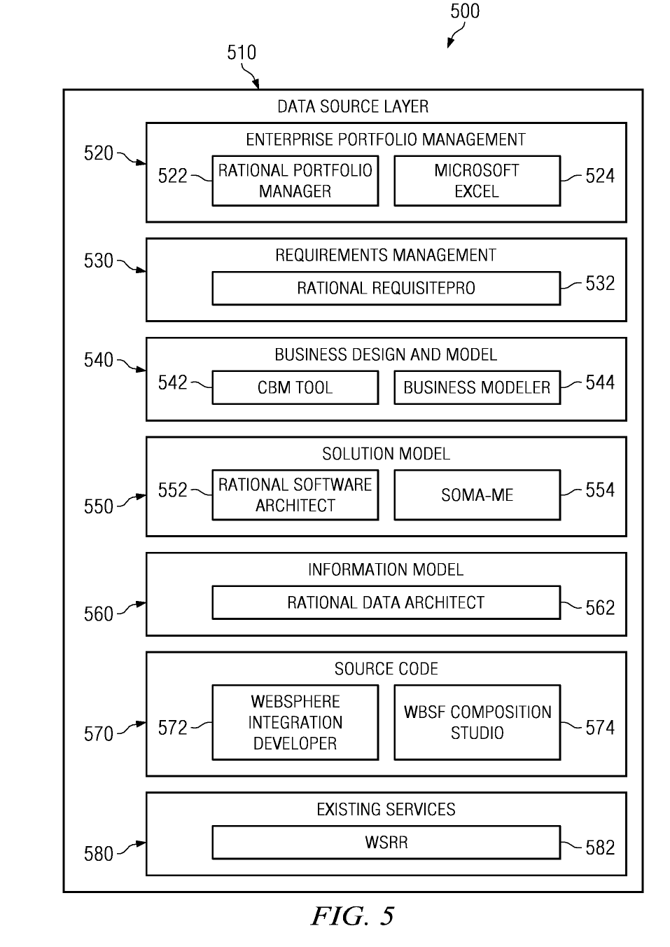

FIG. 5 illustrates a top level diagram 500 of potential sources of data for the SOA dimensional engine. Data source layer 510 may be comprised of a number of processes, tools, and applications. The tools and applications may be part of a heterogeneous information technology environment through an extensive catalogue of data models and tools. Data source layer 510 may comprise, without limitation, enterprise portfolio management 520 application, a requirements management 530 application, a business design and model 540 information, a solution model 550, an information model 560, source code 570, and other existing services 580. All information regarding the services and assets of an enterprise may be represented within data source layer 510. Each asset or service within data source layer 510 may include specific tools or applications. For example, enterprise portfolio management 520 may be comprised of, without limitation, rational portfolio manger 522 and Microsoft® Excel® 524. Requirements management 530 may be comprised of a tool, such as Rational® RequisitePro® 532. Business design and model 540 may be comprised of a curriculum-base measurement (CBM) tool 542 and/or a business modeler 544. Solution model 550 may be comprised of a Rational® Software Architect 552 tool and a design modeling platform, such as the modeling and architecture modeling environment (SOMA-ME). Information model 560 may be comprised of, without limitation, model development tools, such as Rational® data architect 562. Rational® and RequisitePro® are trademarks or registered trademarks of International Business Machines Corporation in the United States, other countries, or both. Microsoft and Excel are either registered trademarks or trademarks of Microsoft Corporation in the United States and/or other countries.

Data source layer 510 may also include source code 570 applications that enable the integration and development of business solutions. Source code may include two applications, such as an integration developer 572 and a composition studio 574 business service that may be used to define a business services environment. Data source layer 510 may also include existing services 580 that comprises a service registry and repository (SRR) 582.

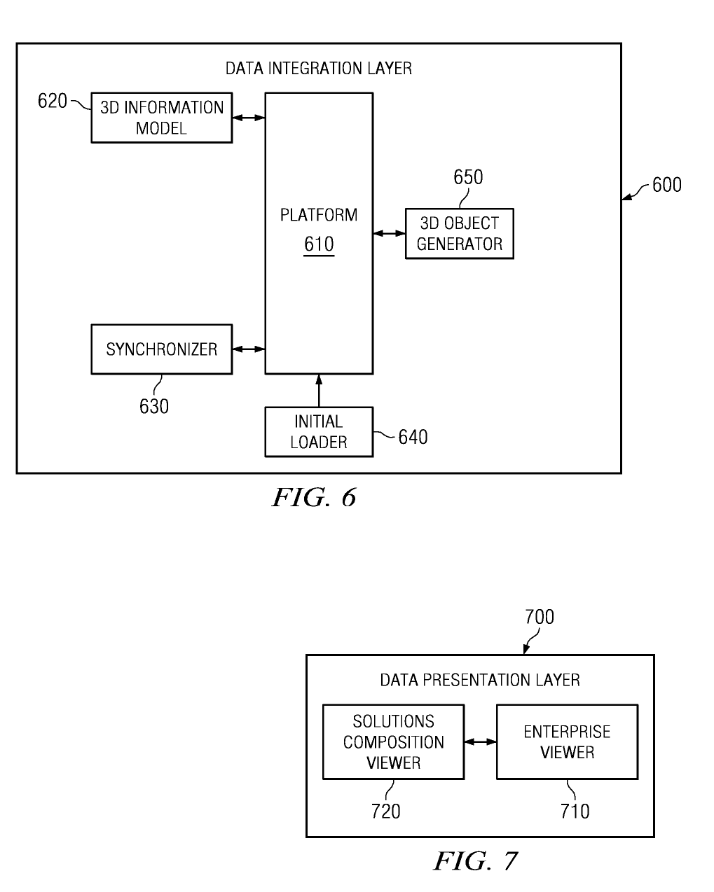

FIG. 6 provides details of a data integration layer 600. Data integration layer 600 sources data from data source layer, such as data source layer 510 in FIG. 5, and integrates and transforms the data to generate a three-dimensional model of data relationships. Data integration layer 600 may include, but is no way limited to, components such as a modeling platform 610, a three-dimensional information model 620, a synchronizer 630, an initial loader 640, and a three-dimensional object generator 650. Platform 610 may be a modeling framework that enables integration and transformation of data from a data source layer. Platform 610 may require that the data be in a specific format, such as an XML. Synchronizer 630 synchronizes the tool information that may be input from a data source layer, such as data source layer 410, to data integration layer 600. Initial loader 640 inputs the data and/or tool information in a specified format to platform 610. Platform 610 maps the information received through initial loader 640 to three-dimensional information model 620. Three-dimensional information model 620 captures data and associates the data within a hierarchy or topology of relationships. The hierarchical information that exists in three-dimensional information model 620 may be transformed and mapped by three-dimensional object generator 650. Three-dimensional object generator 650 may parse the three-dimensional information model 620 to generate a three-dimensional rendering to a display adapter. The three-dimensional information model 620 may be in a common format, such as an XML or other common format that may be known to one skilled in the art.

FIG. 7 illustrates a visual layer that renders the information aggregated and transformed by a data integration layer such as data integration layer 600. In FIG. 7, data presentation layer 700 may be comprised of enterprise viewer 710 and solutions composition viewer 720. Enterprise viewer 710 may visually represent the data from data integration layer 600 in a three-dimensional format. In a preferred embodiment, the three-dimensional format models a cube with a number of different facets. The enterprise here may provide a visual display of all lines of business that may cross a company. The enterprise viewer 710 enables business components to be related to projects that may be operational and may identify services that may be required for a specific business component and/or project.

The solutions composition viewer 720 may input information from enterprise viewer 710 and data from a data integration layer, such as data integration layer 600. Solution composition viewer 720 may include tasks and services associated with the task that may be needed to build or formulate a particular solution for a business enterprise. Solution composition viewer 720 may enable any composition of a solution to a business problem by graphically modeling through a screen or display a number of various relationships between tasks and services.

In summary, a data presentation layer 700 allows a visual display of business components within an enterprise. Information relating to each business component may be selected and related to a business project within an enterprise viewer 710. Services that are being developed within a number of projects may be assigned through the enterprise viewer 710 or the solutions composition viewer 720 to a specific business component. It may be determined through the data presentation layer 700 when projects will be delivered, completed, and also what attribute may be associated with a particular service. The solutions composition viewer 720 may enable a rendering of a modeling or composition of a solution being explored by a business enterprise.

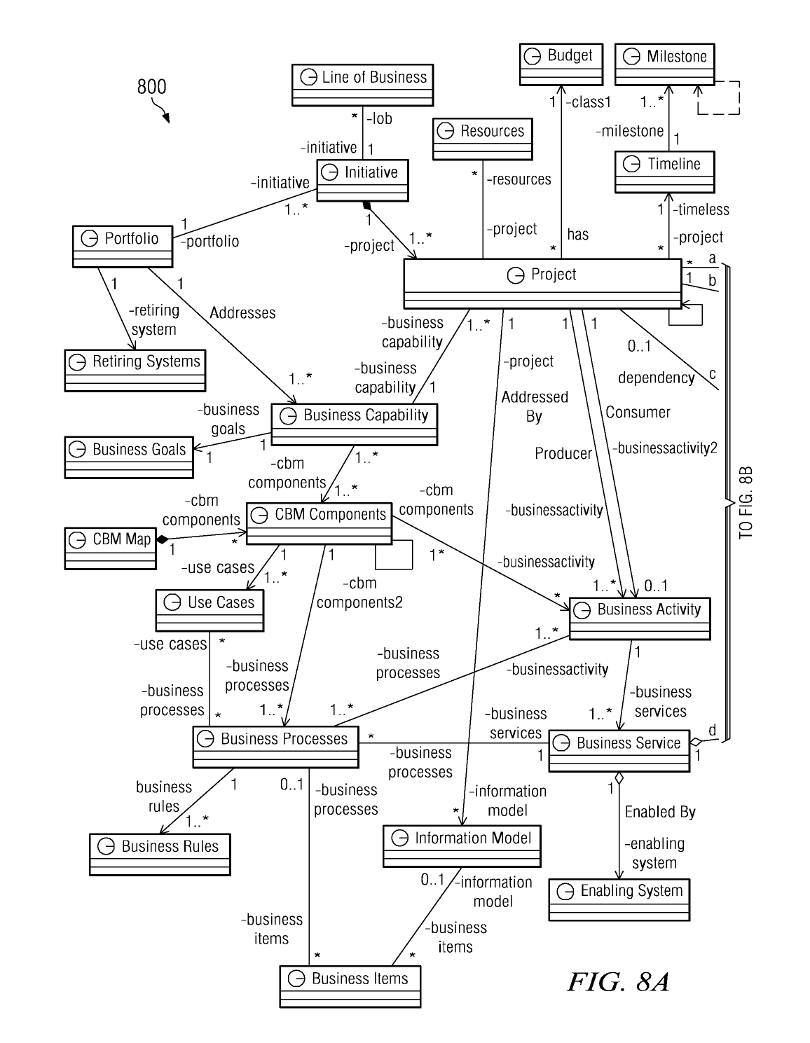

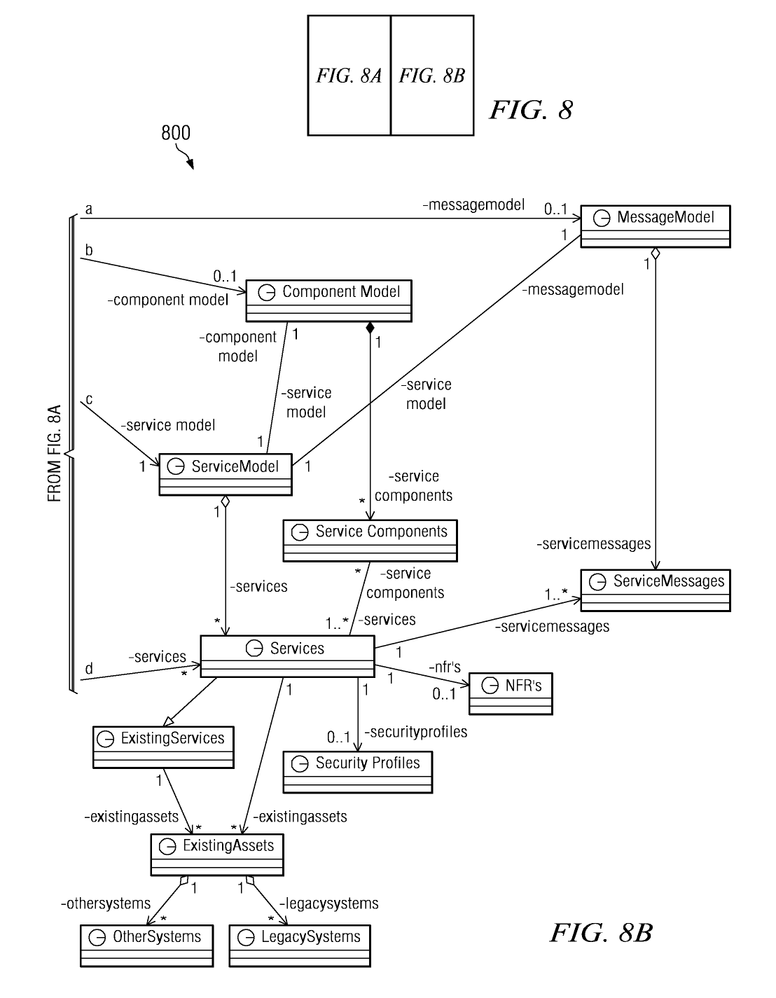

FIGS. 8A and 8B illustrate an exemplary representation of an information model that enables the data to be viewed in a three-dimensional format. Information model 800 may be populated with tool data and/or other asset and service data that may provide the relationship between business components across an enterprise. This information may be instructed by an enterprise viewer, such as enterprise viewer 710 and various perspectives of information may be rendered. And further, information model 800 may be used by a solutions composition viewer, such as solution composition viewer 720, to interactively compose a solution to a business problem that may exist within an enterprise based on the data that populates the information model 800.

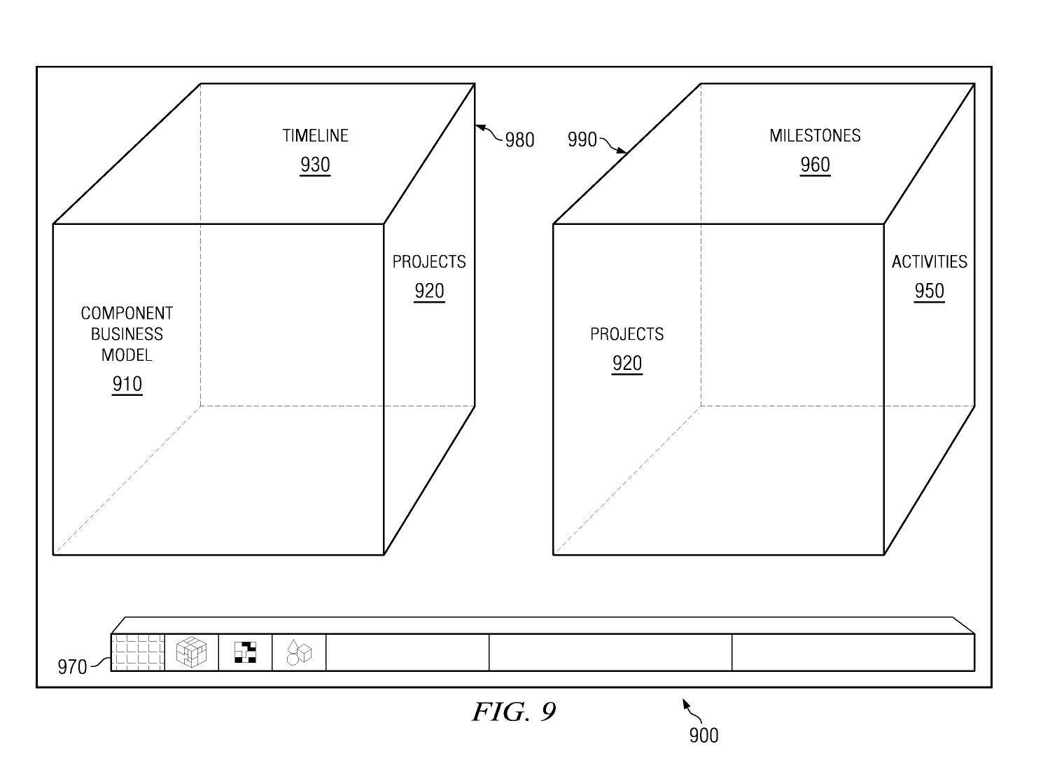

FIG. 9 illustrates virtual information that may be displayed in a three-dimensional cube display 900 on a number of faces of a three-dimensional model, such as a cube. It must be noted that FIG. 9 presents information that may be displayed in an enterprise viewer, such as enterprise viewer 710. In FIG. 9, cube 980 illustrates a component business model 910 view, a projects 920 view, and a timeline 930 view. Component business model 910 view may represent a mapping of all business components that are used for execution and operation of a business enterprise. The projects 920 view may relate existing projects within a business enterprise to the component business model 910. A timeline 930 view may provide visual information on expected completion of projects within projects 920 view or other underlying activity than component business model 910.

In FIG. 9, cube 990 provides different perspectives of three-dimensional cube display 900. An activities view 950 that is associated with a projects 920 view of the component business model 910 may be displayed. A milestones 960 view that tracks the progress of projects 920 within a component business model 910 may be displayed. It must be noted that a component business model 910 may include a number of attributes that may be associated with any component business model 910 and display within the three-dimensional model 900, such as the three-dimensional cubes 980 and 990. Three-dimensional toolbar 970 may rotate and/or change the group perspective of three-dimensional cube 900. Each perspective may provide different views of the enterprise such as a component business model 910 view, a projects 920 view, and an activities 950 view, and other such views or dimensions that may be integral to an enterprise.

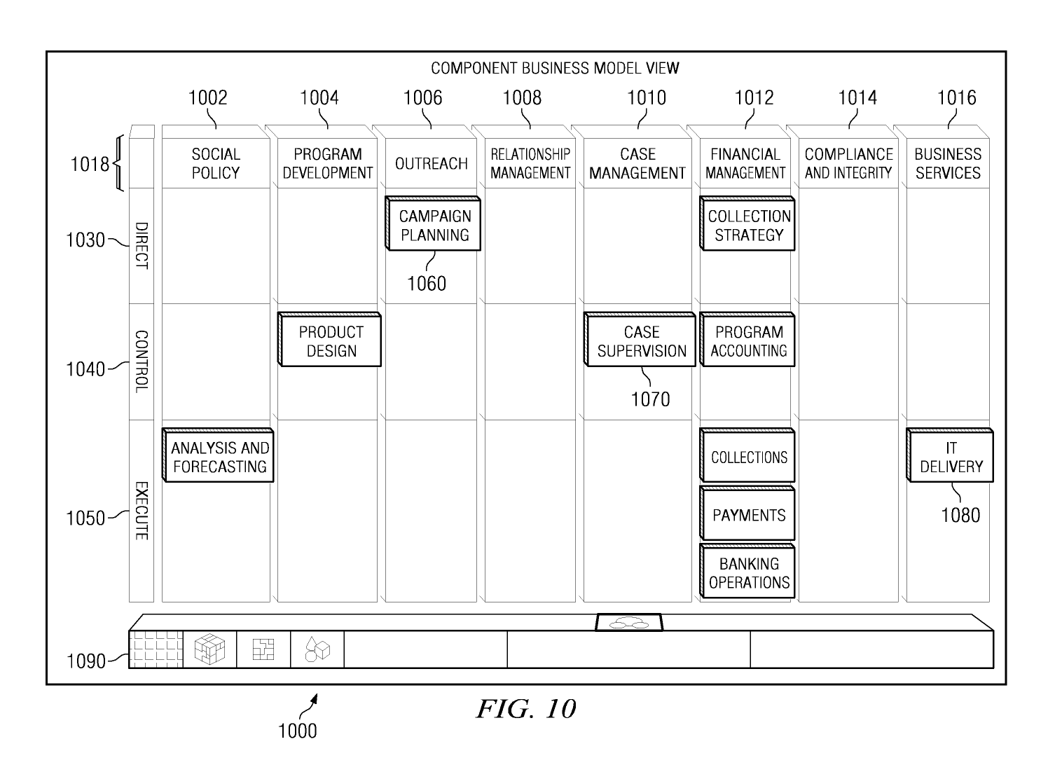

FIG. 10 illustrates an exemplary component business model view 1000 of an enterprise. Component business model view 1000 illustrates various components that may exist across a business enterprise. The various lines of businesses within a business enterprise may include business components such as social policy 1002, relationship management 1008, financial management 1012, and business services 1016. The business components may be organized within a specific rule of the view, such as row 1018. The business component may be organized according to executive functions that include a direct 1030 function, a control 1040 function, and an execute 1050 function. It must be noted that although only three executive functions are illustrated, the number of executive functions is in no way limited to three and will vary depending on the enterprise being examined. The various business components may correspond to various executive function and may organize accordingly within each executive function. For example, campaign planning 1060 is illustrated as being associated with a direct 1030 executive function. Case supervision 1070 is illustrated as being associated with a control 1040 executive function. Information technology (IT) delivery 1080 is illustrated as being associated with a execute 1050 executive function. Toolbar 1090 may be used to select various business components within component business model view 1000 and associate a number of business model components with various predetermined executive functions of an enterprise.

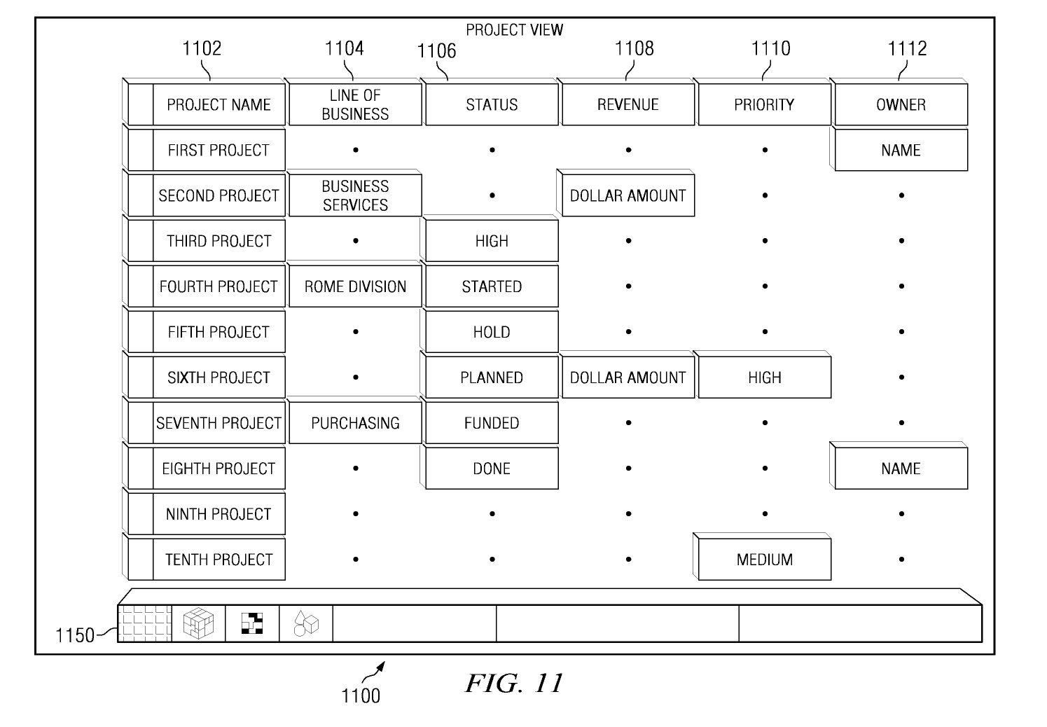

FIG. 11 illustrates a project view 1100 of an enterprise that may be displayed on a different perspective of a three-dimensional model. Project view 1100 can be represented by a projects table that includes a project attribute such as a project name 1102, project line of business 1104, project status 1106, project revenue 1108, a project priority 1110, and a project owner 1112. Three-dimensional toolbar 1150 may select a project for examination and then determine which business component in the component business model view relates to the selected project. It must be noted that more than one business component may be related to the selected project. A number of projects may be selected and associated with one or more component business models.

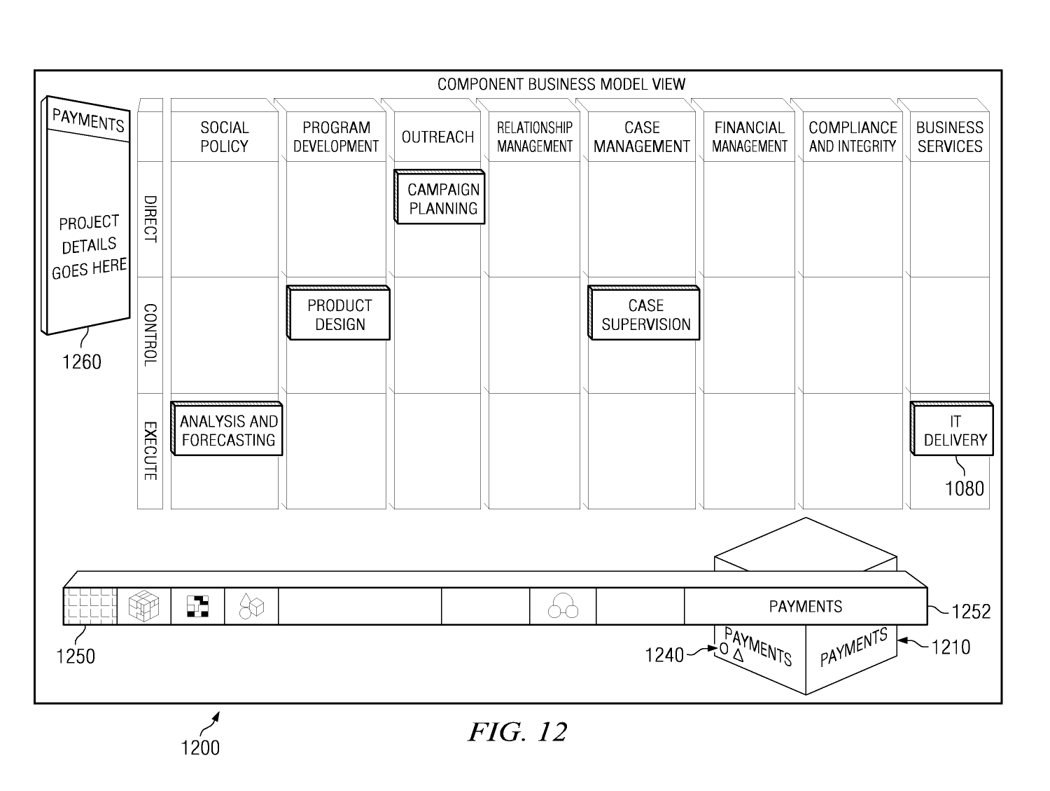

Turning now to FIG. 12, a specific business component may be selected for analysis. Heat map values associated with each business component may determine the priority of selection of each business component. For example, business component payments 1210 may be selected by tool bar 1250 for review and analysis based on its associated heat map value 1240. The details of the selected project payments 1210 may be recorded and displayed on a separate window, such as popup window 1260, for further analysis. Tool bar 1250 controls the selection of business component payments 1210. The contents of the tool bar 1250 may change to indicate which business component is selected. For example, toolbar 1250 may select business component 1210 for review and analysis. A field 1252 of toolbar 1250 may then change to indicate that the payments 1210 business component is selected. An analysis of business components related to the selected business component payments 1210 may also occur.

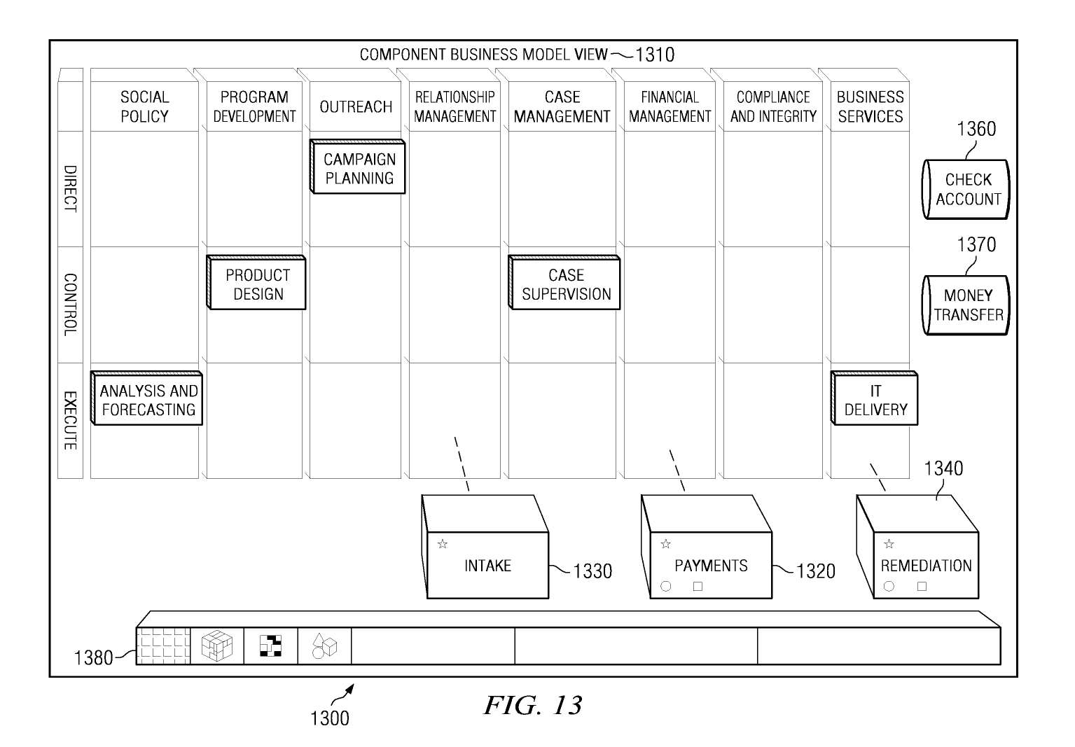

In FIG. 13, diagram 1300 illustrates the selection of business component intake 1330 and remediation 1340 that are related to business component payments 1320. Additionally, the component business model 1310 may enable the analysis of services related to selected business components. For example, selection of business component payments 1320 may enable a determination of the services that are related to payments 1320. In this example, a query to determine which services are related to payments 1320 determine information on check account 1360 and money transferred 1370. It may also be possible to examine which projects are linked to each service. For example, check account 1360 could be associated with a number of projects. Similarly, money transferred 1370 service may be associated with a number of different projects. It may be possible to determine which projects are associated with check account service 1360 and the money transfer service 1370 and view this association within the three-dimensional environment, and more specifically, from the project perspective.

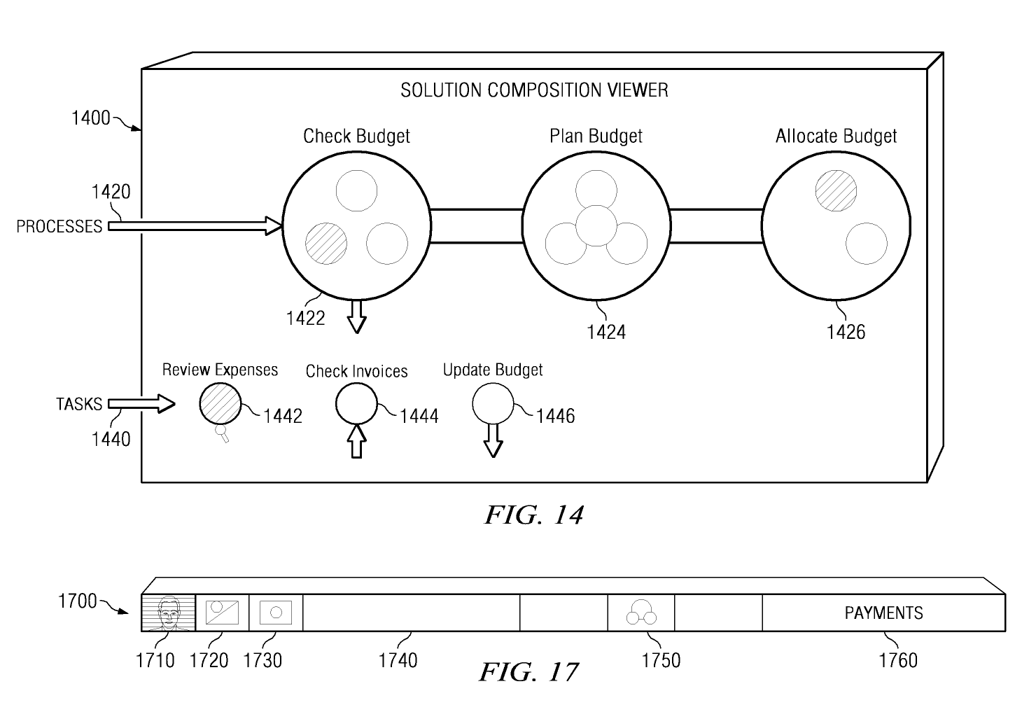

FIGS. 14-16 illustrate processes of the solution composition viewer. Turning first to FIG. 14, solution composition viewer 1400 includes selected processes 1420 of check budget 1422, plan budget 1424, and allocate budget 1426. It must be noted that although only three processes are shown in solution composition 1400, the number of processes is not limited to three. The number of processes may vary depending on the particular enterprise or problem that is being analyzed. Each process may be associated with tasks 1440. For example, process check budget 1422 may be associated with task of view expenses 1442, check invoices 1444, or update budget 1446. The solution composition viewer may be able to indicate whether a problem exists within a process. For example, within the task associated with check budget 1422, task review expenses 1442 may be flagged as being unresolved or having a problem. The problem may be that no services are associated with task review expenses 1442.

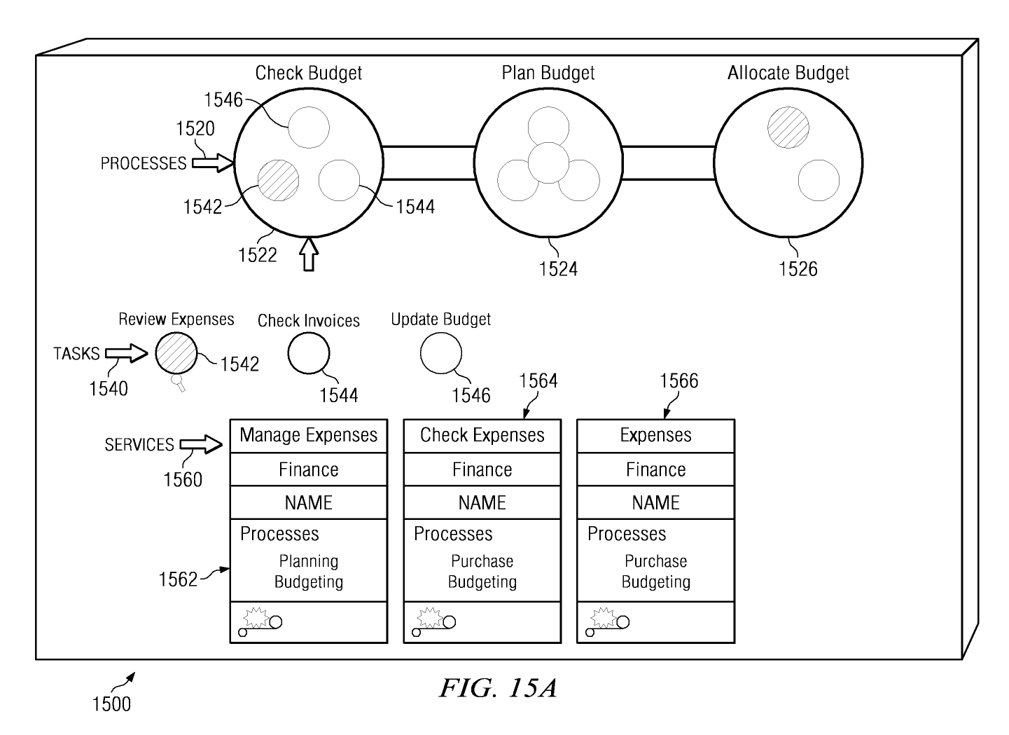

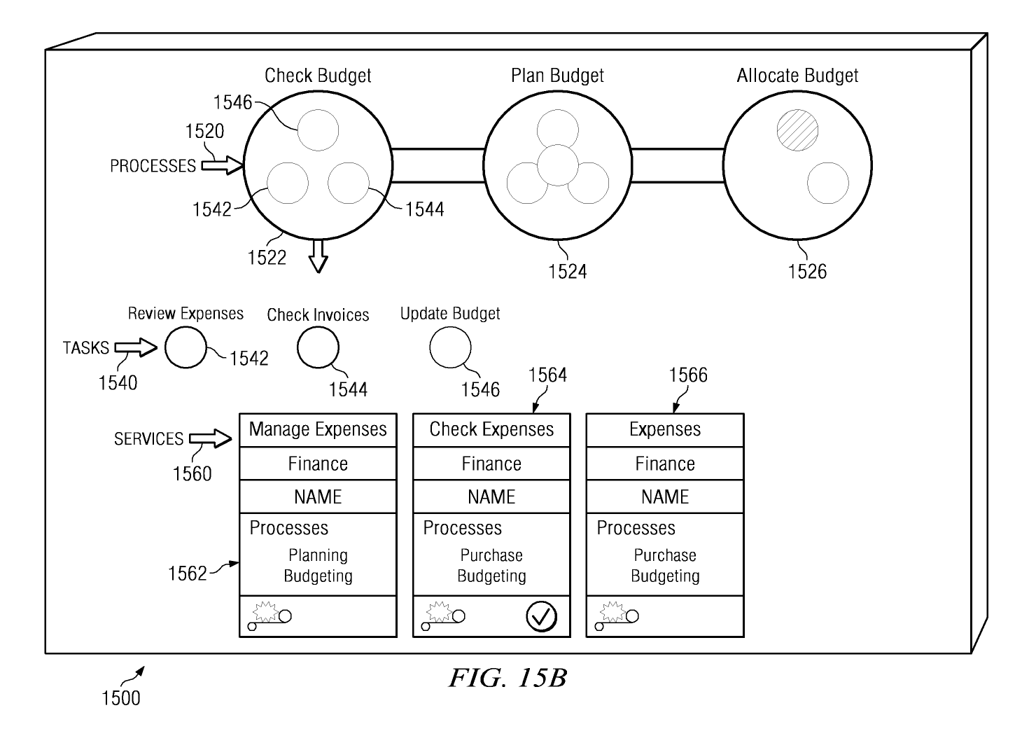

In FIG. 15A, services that may be related to task review expenses 1542 are displayed. The services 1560 may comprise, without limitation, manage expenses 1562, check expenses 1564, and expenses 1566. As shown in FIG. 15B, task review expenses 1542 is resolved by associating the service, check expenses 1564, with the task, review expenses 1542.

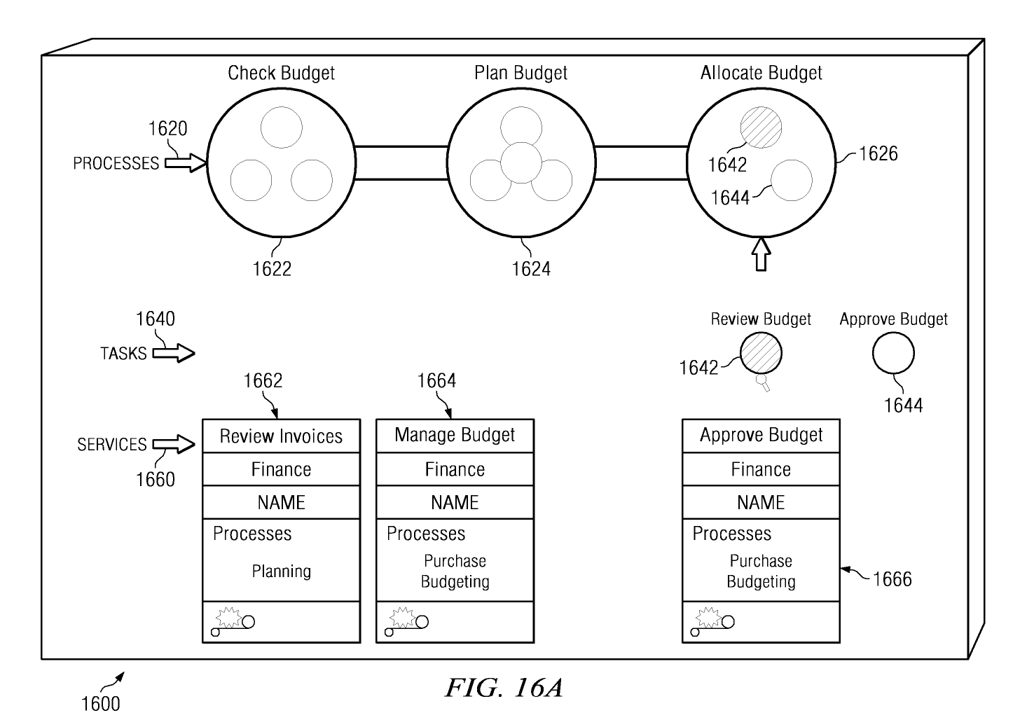

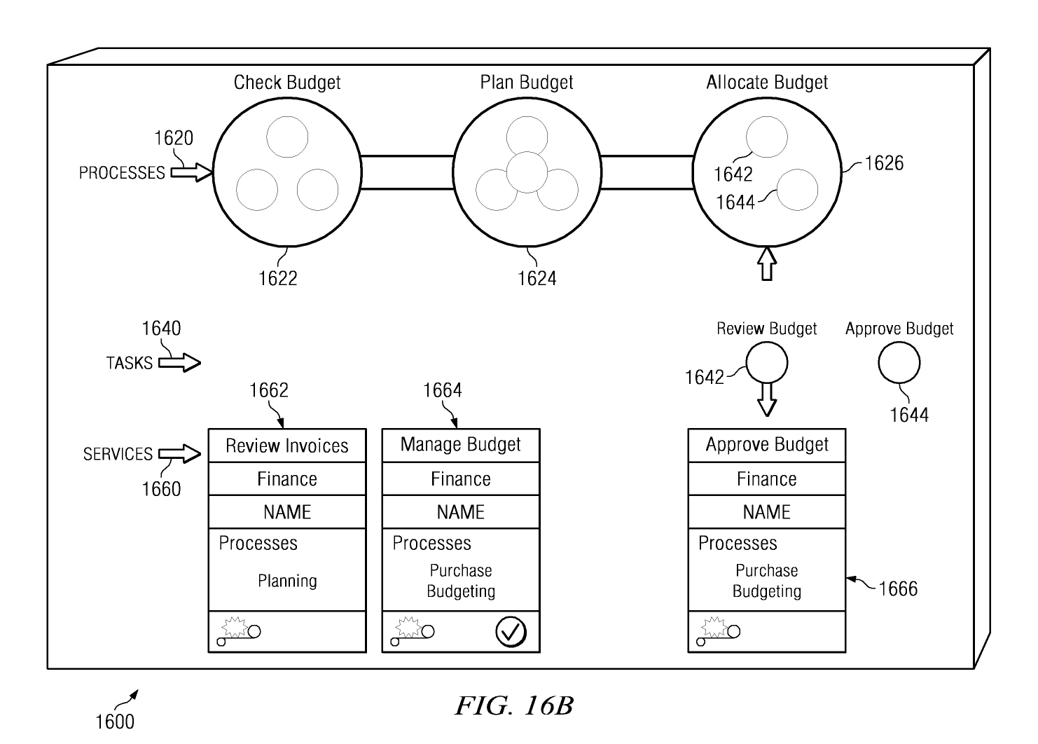

Similarly, in FIG. 16A, diagram 1600 illustrates that process allocate budget 1626 includes an unresolved task 1640 review budget 1642. The services associated with task 1642 maybe displayed. In this example, services 1660 associated with task review budget 1642 may comprise review invoices 1662, manage budget 1664, and approve budget 1666. It must be noted that the number of services associated with review budget 1642 is for illustrative purposes only. In FIG. 16B, associating the service manage budget 1664 with the task review budget 1642 may resolve the problem indicated by review budget 1642.

FIG. 17 illustrates a three-dimensional toolbar 1700 that may be used to navigate through the visual information on a display. The three-dimensional toolbar 1700 may be considered as a user interface widget that is always in full view on a screen of a display. The three-dimensional toolbar 1700 may be three-dimensional and may include options for viewing a three-dimensional cube on display. The viewing options of the three-dimensional toolbar may be controlled by a number of buttons on three-dimensional toolbar 1700. A number may refer to any number greater than zero. The buttons on the three-dimensional toolbar may include, but are in no way limited to, buttons including 1710, 1720, 1730, 1740, 1750 and 1760. It must be noted that the number and functions of the buttons on the three-dimensional toolbar are exemplary. The number and function may be configured in accordance with a specific enterprise or application.

In an embodiment, button 1710 of three-dimensional toolbar 1700 may be used to change or switch a perspective or view of a screen or an object displayed on the screen. Button 1720 of three-dimensional toolbar 1700 may be used to switch or turn the three-dimensional cube from a current perspective to a second perspective or view. Button 1730 of three-dimensional toolbar 1700 may be used to activate special functions within a current perspective. For example, one special function that may be activated through selection of button 1730 may include a heat map. Another special function activated through selection of button 1730 may include a rotation of the three-dimensional cube. Button 1750 of three-dimensional toolbar 1700 may be used to provide another kind of functionality within a current perspective. For example, if a heat map perspective is illustrated, selection of button 1750 may be used to show related components. Button 1760 of three-dimensional toolbar 1700 may be used to provide feedback regarding a current three-dimensional object on display. Buttons 1740 and 1750 of three-dimensional toolbar 1700 may be used to apply certain functions. Functions may be, without limitation, the different relationships that exist with an information model, such as the information model of FIG. 8.

In an embodiment, three-dimensional toolbar 1700 may include a voice user interface controlled by voice recognition software. The three-dimensional toolbar 1700 may audibly notify a user of changes of any options on three-dimensional toolbar 1700 as it rotates and changes in response to the context of an environment. For example, as the context of the environment changes, the content of the three-dimensional toolbar 1700 may change to enable different tools, controls, and information regarding the new context. The three-dimensional toolbar 1700 may audibly alert the user to options and selections that may be made. For example, a context may be a Project View and the three dimensional toolbar 1700 may alert the user that “selection of projects is now enabled.” In another example, a context may be a component business model view and the three dimensional toolbar 1700 may alert the user that “heat map is now enabled.”

The three-dimensional toolbar 1700 may be rectangular or circular or some other selected configuration. Three-dimensional toolbar 1700 may change content, such as the buttons or information, depending on where a user is located in the three-dimensional screen of the display. The location of a user in the display may be determined by the position of a cursor in the three-dimensional display. The three-dimensional toolbar 1700 may rotate and some of the content of the visual display may adjust as perspectives within a current view change. Multiple portions of three-dimensional toolbar 1700 may rotate and change independently. For example, button 1710 may change content and/or rotate based on a current display. Similarly, button 1720 may rotate and change depending on the content of a current display. Button 1710 and button 1720 may rotate and change independently of the changes of each respective button on three-dimensional toolbar 1700.

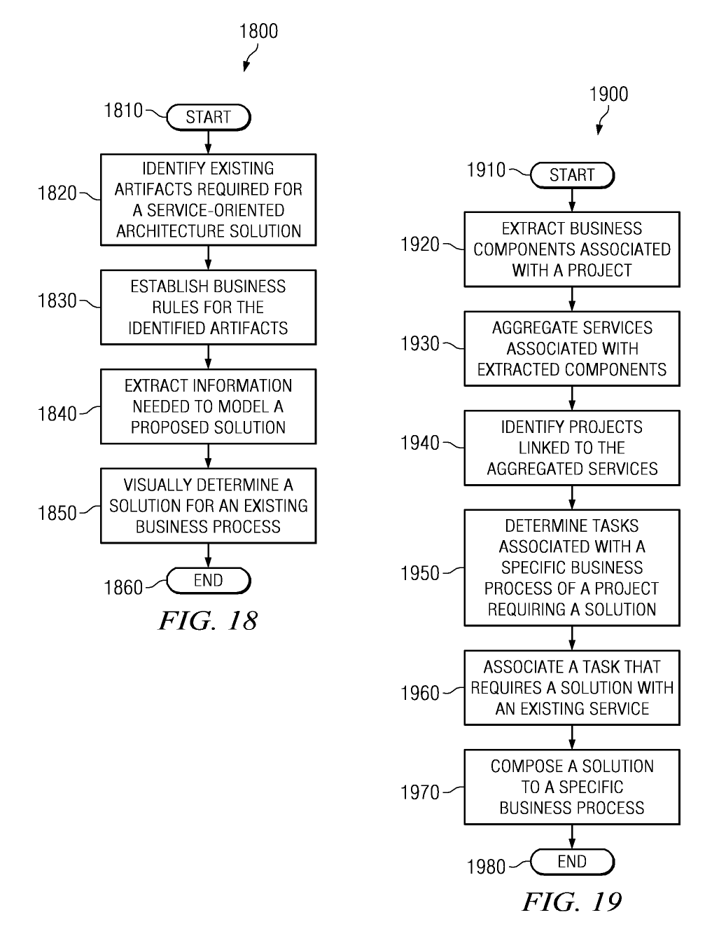

FIG. 18 illustrates a top level exemplary flow. The process may start at 1810 with the identification of existing artifacts required for a service oriented architecture solution at 1820. At 1830, rules may be established for the identified artifacts. The rules may be business rules that are derived by inference, estimation, an empirical estimation, or other such derivation that may be recognized by one skilled in the art. The rules may be part of a rules engine and may be stored in a database. At 1840, information needed to model a proposed solution may be extracted. At 1850, a model may be composed to visually determine a solution for an existing process of an enterprise.

In FIG. 19, flowchart 1900 provides a more detailed flow. The method may start at 1910 with the extraction of business components associated with a project at block 1920. At block 1930, the services associated with extracted components are aggregated. At 1940, projects linked to the aggregated services are identified. At block 1950, tasks that may be associated with a specific business process of a project that requires a solution may be determined. At block 1960, a task that requires a solution is associated with an existing service. A solution is thereby composed to the specific business process at block 1970. The process may end at block 1980.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing a specified logical function. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, and other software media that may be recognized by one skilled in the art.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. In an enterprise management framework, a computer implemented method of modeling a solution for a business process with a tool that generates multiple dimensional views, the computer implemented method comprising:
automatically extracting a number of business components, from a component business model view, a number of components being associated with a project selected from a project view of the enterprise management framework;
determining, from the component business model view, a number of services implemented for each extracted business component;
identifying, from the component business model view, a specific component from the extracted business components based on a heat map value;
aggregating the services associated with the identified component;
identifying, through the project view, a number of projects linked to the aggregated services;
determining, in a service composition view, tasks associated with a specific business process of a project that requires a solution;
associating a task that requires a solution with an existing service; and
composing, in the service composition view, the solution to a specific business process.

2. The computer implemented method of claim 1, wherein the composing is generated in a three-dimensional format.

3. The computer implemented method of claim 1, wherein the automatic extraction is based on an information model.

4. The computer implemented method of claim 1, wherein the composing is based on pre-selected business rules.

5. The computer implemented method of claim 4, wherein the pre-selected business rules are inferential rules.

6. In an enterprise management framework, a computer implemented method of modeling a solution for a business process, the computer implemented method comprising steps of:
identifying existing artifacts required for a service-oriented architecture solution;
establishing business rules for the identified artifacts;
extracting information needed to model a proposed solution; and
visually determining a solution for the business process.

7. The computer implemented method of claim 6, wherein the step of extracting information is based on an information model.

8. The computer implemented method of claim 6, wherein the step of visually determining is based on a three-dimensional model.

9. A three dimensional interactive user interface tool, the three dimensional interactive user interface tool comprising:
a three dimensional user interface that adapts to changes in an environment; and
a number of portions that perform navigation of a three dimensional model, wherein at least one portion of the tool is updated with informational data responsive to the navigation.

10. The three dimensional interactive user interface tool of claim 9, wherein the portions comprise buttons that enable functions within an environment.

11. The three dimensional interactive user interface tool of claim 9, further comprising a voice user interface.

12. The three dimensional interactive user interface tool of claim 11, wherein the voice user interface issues audible alerts.

13. The three dimensional user interface tool of claim 9, wherein the three dimensional user interface is rectangular.

14. The three dimensional user interface tool of claim 9, wherein the three dimensional user interface is circular.

15. The three dimensional user interface tool of claim 9, wherein the number of portions rotate and change content independently of any other portion.

16. The three dimensional user interface tool of claim 9, wherein the three dimensional user interface is rectangular.
